(19) United States
(12) Patent Application Publication
(10) Pub. No.: US 2003/0142086 A1
(43) Pub. Date: Jul. 31, 2003

(54) Image projecting device

(76) Inventors: Mitsuyoshi Watanabe, Gifu-ken (JP); Shoji Yamada, Aichi-ken (JP)

Correspondence Address: Gerald Levy, Exq., PITNEY, HARDIN, KIPP & SZUCH LLP, 685 Third Avenue, New York, NY, 10017-4024, US

(21) Appl. No.: 10/354,315

(22) Filed: Jan. 30, 2003

(30) Foreign Application Priority Data
Jan. 30, 2002 (JP) 2002-021756

(51) Int. Cl. G09G 5/00

(52) U.S. Cl. 345/204

(57) ABSTRACT

An image displaying device is provided with at least one light source for emitting a light beam, a modulating system that modulates the light beam in accordance with a video signal, a wavefront curvature modulating system that modulates a wavefront curvature of the light beam, a scanning system that scans the modulated light beam modulated, and an optical system that directs the scanning light beam scanned to a pupil of an observer, thereby forming an image corresponding to he video signal on a retina of an observer. The wavefront curvature modulating system is configured to vary the divergence of the beam incident on the scanning system.

### BACKGROUND OF THE INVENTION

The present invention relates to an image projecting device which emits a scanning light beam into an eye of an observer to form an image on the retina.

Conventionally, a head-mounting display has been suggested. The head-mounting display is a device provided with small LCDs (approximately one square inch) which are secured on a head band or the like. A user of the head-mounting display wears the head band so that the LCDs are located in front of the user's eyes. Typically, by displaying an image to be viewed by a left eye is displayed on a left side LCD, while an image to be viewed by a right eye is displayed on a right side LCD, thereby the user viewing a three-dimensional image because of a parallax created by the difference of the right and left images:

The LCD, which is typically a color LCD, is configured such that, by making use of characteristics of liquid crystal, a degree of closed/opened status of each pixel of Red, Green and Blue color filters are controlled to display a color image. It should be noted that, since the liquid crystal does not emit light, the LCD is configured such that the image is displayed by varying degree of shielding light, which is emitted by a backlight device, at each pixel.

In the conventional display such as the head-mounting display, a positional relationship between the LCD and the retina is constant. Therefore, even though an image projected on the retina of the user appears three-dimensional, the depth of the image is generally insufficient, which causes uncomfortable feelings to the user, and sometimes causes eyestrain of the observer.

Recently, a technology for directly forming an image on a retina of a user by scanning laser beam. An example making use of such a technology is described in Japanese Patent No. 2874208 to the present assignee. In this patent, for providing feeling of perspective, a curvature of wavefront of the laser beam is modulated by varying a curvature of a reflection surface, which reflects the laser beam before it is directed to the user's eye. Recently, it has been desired that the radius of the wavefront curvature is modulated more easily and accurately without complicating the structure of the wavefront curvature modulating device.

### SUMMARY OF THE INVENTION

The present invention is advantageous in that a feeling of perspective providing an image which is sufficiently close to an image of an actual three-dimensional object can be provided.

According to an aspect of the invention, there is provided an image displaying device, which is provided with at least one light source that emits a light beam, a modulating system that modulates the light beam emitted by the at least one light source in accordance with a video signal, a wavefront curvature modulating system that modulates a wavefront curvature of the light beam modulated by the modulating system, a scanning system that scans the light beam modulated by the wavefront curvature modulating system, and an optical system that directs the light beam scanned by the scanning system to a pupil of an observer thereby forming an image corresponding to he video signal on a retina of an observer. Further, the wavefront curvature modulating system includes an optical element, and a moving mechanism that moves the optical element in a direction of an axis of the laser beam.

With this configuration, by moving the optical element along the axis of the laser beam, the wavefront curvature can be varied, which varies the degree of perspective recognized by the observer.

Optionally, the optical element may include a reflector that reflect the beam, and the wavefront curvature modulating system may include a polarizing beam splitter that allows a linearly polarized component, which is polarized in a predetermined direction, of the beam modulated by the modulating system to pass through, and reflects another linearly polarized component, which is polarized in a direction perpendicular to the predetermined direction, of the beam modulated by the modulating system, a light collecting system that collects one of the component passed through the polarizing beam splitter and the reflected component, the collected component being incident on the optical element, and a ¼ λ plate arranged between the light collecting system and the polarizing beam splitter. The ¼ λ plate is configured to be rotatable on a plane perpendicular to the axis of the beam.

Further optionally, the wavefront curvature modulating system may include a position adjustment mechanism independent of the moving mechanism, a position of the optical element being adjusted with the position adjustment mechanism.

According to another aspect of the invention, there is provided an image displaying device, which is provided with at least one light source that emits a light beam, a modulating system that modulates the light beam emitted by the at least one light source in accordance with a video signal, a wavefront curvature modulating system that modulates a wavefront curvature of the light beam modulated by the modulating system, a scanning system that scans the light beam modulated by the wavefront curvature modulating system, and an optical system that directs the light beam scanned by the scanning system to a pupil of an observer thereby forming an image corresponding to he video signal on a retina of an observer. Further, the wavefront curvature modulating system may include an optical element provided with a plurality of reflection surfaces which are arranged at different positions along the axis of the beam.

With this configuration, by switching the reflection surfaces, the wavefront curvature can be varied, which varies the degree of perspective recognized by the observer.

Alternatively, the wavefront curvature modulating system may include a variable focal length optical element whose focal length changes in accordance with variation of at least one of its shape and physical properties.

With this configuration, by varying the focal length, the wavefront curvature can be varied, which varies the degree of perspective recognized by the observer.

Optionally, the wavefront curvature modulating system may include a position adjustment mechanism, a position of the optical element or the variable focal length optical element being adjusted with the position adjustment mechanism.

Further optionally, the wavefront curvature modulating system may include a light detecting system that detects the beam reflected by the optical element, or passed through the variable focal length optical system, and the position adjusting mechanism may be configured to adjust a position of the variable focal length optical element in accordance with a position of the beam detected by the light detecting system.

Still optionally, in the image displaying device mentioned above, the wavefront curvature modulating system may be arranged on a light source side with respect to the scanning system, and a position at which the beam is incident on the scanning system and a position of the pupil of the observer have a conjugate relationship.

According to a further aspect of the invention, there is provided an image displaying device, which is provided with at least one light source that emits a light beam, a modulating system that modulates the light beam emitted by the at least one light source in accordance with a video signal, a scanning system that scans the light beam modulated by the modulating system, and an optical system that directs the light beam scanned by the scanning system to a pupil of an observer thereby forming an image corresponding to the video signal on a retina of an observer. Further provided is a wavefront curvature modulating system that modulates a wavefront curvature of the light beam.

In this configuration, the wavefront curvature modulating system is configured to change a divergence of the beam incident on the scanning system.

Further, the wavefront curvature modulating system may be configured to include a first optical system and a second optical system that is closer to the scanning system than the first optical system. The light beam is converged by the first optical system and then enters the second optical system as a diverging beam. A point at which the light beam is converged by the first optical system is changeable on a second optical system side with respect to a focal point of the second optical system.

With this configuration, since the divergence of the beam incident on the eye can be varied, the degree of perspective recognized by the observer can be adjusted.

Optionally, the wavefront curvature modulating system is arranged on an light source side with respect to the scanning system.

### BRIEF DESCRIPTION OF THE ACCOMPANYING DRAWINGS

FIG. 1 shows a configuration of a retinal scanning display device 1 according to a first embodiment of the invention;

FIGS. 2 and 3 show a configuration of a wavefront curvature modulation system according to the first embodiment;

FIG. 3 illustrates a modulation of a laser beam using a wavefront curvature modulation system;

FIGS. 4 and 5 show a configuration of a wavefront curvature modulation system according to a first modification of the first embodiment;

FIG. 6 is a flowchart illustrating a position adjustment procedure employed in the first modification;

FIG. 7 shows a configuration of a wavefront curvature modulation system according to a second modification of the first embodiment;

FIGS. 8 and 9 are front views of ¼ λ plate employed in the second modification;

FIGS. 10 and 11 show a configuration of a wavefront curvature modulation system according to a third modification of the first embodiment;

FIG. 12 shows a configuration of a retinal scanning display device 1M according to a second embodiment of the invention; and

FIGS. 13 and 14 show a configuration of a wavefront curvature modulation system according to the second embodiment.

### DESCRIPTION OF THE EMBODIMENTS

Hereinafter, retina scanning displays according to embodiments of the present will be described with reference to the accompanying drawings.

### First Embodiment

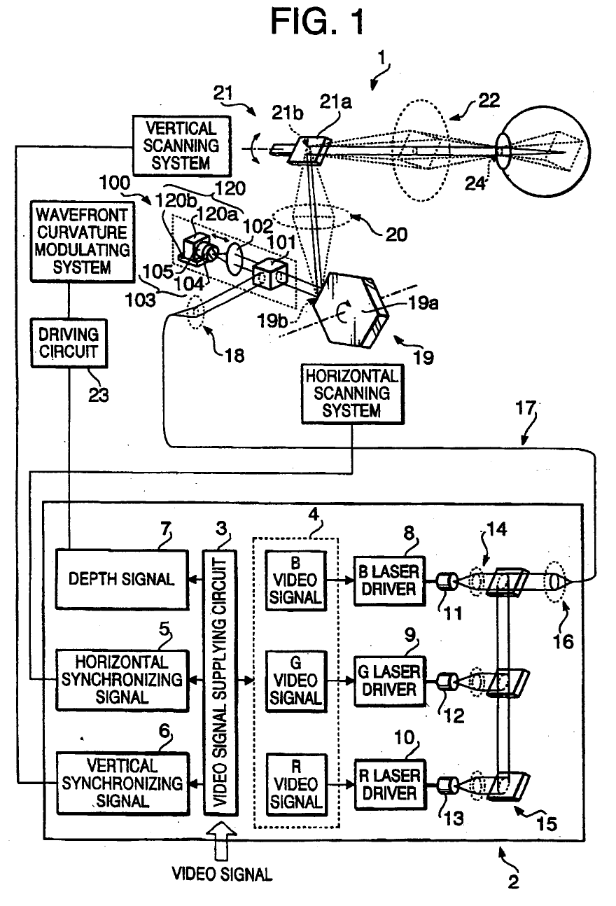

FIG. 1 shows a configuration of a retinal scanning display device 1 according to a first embodiment of the invention.

As shown in FIG. 1, the retinal scanning display 1 includes a light source unit 2 that processes video signals supplied by an external device.

The light source unit 2 is provided with a video signal supplying circuit 3, which receives the video signal from the external device and generates component signals for displaying an image. Specifically, the video signal supplying circuit 3 outputs a video signal 4, a horizontal synchronizing signal 5, a vertical synchronizing signal 6 and a depth signal 7.

The light source unit 2 is further provided with R (red) laser diode 13, G (green) laser diode 12 and B (blue) laser diode 11 respectively driven in accordance with R, G and B components of the video signal 4 supplied by the video signal supplying circuit 3. Specifically, the R, G and B components of the video signal 4 are input to R laser driver 10, G laser driver 9 and B laser driver 8 which drive the R, G and B laser diodes 13, 12 and 11, respectively.

In front of (on light emitting side of) the R, G and B laser diodes 13, 12 and 11, first collimating optical systems 14 are arranged, respectively, for collimating the laser beams emitted by the R, G and B laser diodes 13, 12 and 11.

The laser beams emitted by the R, G and B laser diodes 13, 12 and 11 are incident on dichroic mirrors 15 which selectively transmits/reflects beams incident thereon depending on wavelengths of the beams. Specifically, as shown in FIG. 1, the dichroic mirrors 15 are configured/arranged such that the laser beams emitted by the R, G and B laser diodes 13, 12 and 11 are finally combined and incident on an imaging optical system 16 as a single laser beam including the R, G and B components.

The combined beam is converged on an entrance end surface of an optical fiber by the imaging optical system 16.

The retinal scanning display device 1 further includes a second collimating optical system 18 that collimates the laser beam emitted from the light source unit 2, a wavefront curvature modulating system 100 that modulates a wavefront curvature of the collimated laser beam, a horizontal scanning system 19 that scans the modulated laser beam in a horizontal direction using a polygonal mirror 19a, and a vertical scanning system 21 that scans the laser beam output by the horizontal scanning system 19 and incident on the vertical scanning system 21 via a first relaying optical system 20. The vertical scanning system 21 includes a galvano mirror 21a that scans the laser beam, which scans in the horizontal direction, in the vertical direction. Thus, the laser beam scans two-dimensionally.

The scanning beam is incident on a pupil 24 of an observer via a second relaying optical system 22.

It should be noted that the first relaying optical system 20 is arranged such that a surface of the polygonal mirror 19a and the reflection surface of the galvano mirror 21a have a conjugate relationship. Further, the second relaying optical system 22 is arranged such that the reflection surface of the galvano mirror 21a and the pupil 24 of the user have a conjugate relationship.

The driving circuit 23 drives the wavefront curvature modulating system 100 in accordance with the depth signal 7 output by the video signal supplying circuit 3. The horizontal scanning system 19 and the vertical scanning system 21 are connected with the video signal supplying circuit 3, and scan the laser beam synchronously with the horizontal synchronizing signal 5 and the vertical synchronizing signal 6, respectively.

The wavefront curvature modulating system 100 includes a beam splitter 101 that splits an incident laser beam into a transmitted beam passed through the beam splitter 101 and a reflected beam which is reflected by the beam splitter 101 and directed in a direction perpendicular to the transmitted beam.

The wavefront curvature modulating system 100 further includes a positive lens 102 that has a positive power and converges the reflected beam, a movable mirror 103 that reflects back the beam converged by the positive lens 102 toward the positive lens 102.

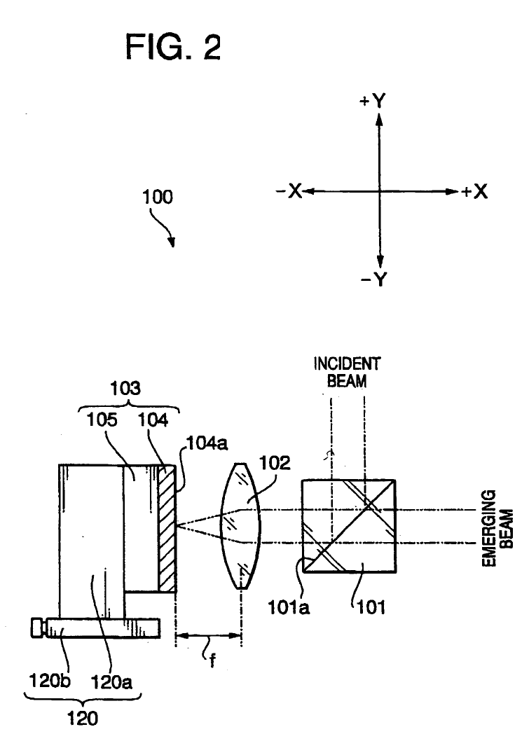

According to the first embodiment, the beam splitter 101 is configured such that a pair of rectangular prisms are cemented at the oblique surfaces, with dielectric multiple-layer film being provided therebetween, and that the cemented prisms form a cubic shape. The oblique surfaces and the dielectric multiple-layer film constitute a beam splitting surface 101a (i.e., a half-mirror surface), which transmits approximately 50 percents of the incident beam and reflects approximately 50 percents of the incident beam in a direction perpendicular to a direction where the transmitted beam proceeds (see FIG. 2).

The movable mirror 103 is configured, for example, such that a mirror surface 104a of a movable mirror 104, which is a transparent plate member such as a glass plate applied with a mirror coating metallic layer, and a piezoelectric actuator 105 having multiple layers of piezoelectric elements. The piezoelectric actuator 105 is driven as a driving voltage is applied by the driving circuit 23. When the piezoelectric actuator 105 is driven, a positional relationship between the movable mirror 104 and the positive lens 102 is changed in a direction perpendicular to a plane of the mirror surface 104a (X-axis direction in the drawings). It should be noted that the central axis of the laser beam reflected by the mirror surface 104a and passed through the positive lens 102 and the central axis of the beam passed through the beam splitter 101 are on the same line.

Further, the movable mirror 103 is secured on a movable unit 120a of a position adjustment mechanism 120 that is used for a fine adjustment of a reference position of the movable mirror 103 in the direction of the optical axis. A distance between the positive lens 102 and the movable mirror 103 can be adjusted by rotating a screw of a screw-feeding fine movement table 102b fixed on the movable unit 120a.

The position adjustment mechanism 120 is provided so that the user (observer) can locate the movable mirror 103 to a reference position when no voltage is applied to the piezoelectric actuator 105 or a predetermined reference voltage for the position adjustment is applied to the piezoelectric actuator 105.

Optical systems generally include minute individual differences. Therefore, it is necessary to adjust the initial location of the movable mirror 103 where the laser beam has a predetermined wavefront curvature. With this position adjustment mechanism 120, differences of focal points due to individual differences of users can also be dealt with, and an expected effects of the wavefront curvature modulating system 100 can be achieved.

Next, an operation of the retinal scanning display device 1 according to the first embodiment will be described with reference to FIG. 1.

When the video signal supplying circuit 3 receives a video signal from the external device, the video signal supplying circuit 3 generates the R video signal, G video signal, B-video signal respectively corresponding to R, G and B components, the horizontal synchronizing signal 5, the vertical synchronizing signal 6 and the depth signal 7.

The R laser driver 10, G laser driver 9 and the B laser driver 8 output, in accordance with the input R, G and B video signals, driving signals to the R laser diode 13, G laser diode 12 and B laser diode 11, respectively. The laser diodes 13, 12 and 11 emit the laser beams in accordance with the driving signals output by the R laser driver 10, G laser driver 9 and the B laser driver 8. The emitted laser beams are collimated by the first collimating optical systems 14, and are combined into a single beam via the dichroic mirrors 15. The combined beam is then converged on the end surface of the optical fiber 17 by the imaging optical system 16. The laser beam transmitted by and emerged from the optical fiber 17 is collimated by the second collimating optical system 18 and is incident on the wavefront curvature modulating system 100.

It should be noted that the invention is not limited to this configuration, and solid state lasers may be used instead of the laser diodes 11 through 13.

The modulation of the wavefront curvature will be described.

Light emitted by a light source propagates as a light wave in all directions at the same phase, i.e., as isophase spherical wave. Depending on a distance between the light source and an observer, the radius of curvature of the spherical wave at the observer is different. That is, if the light source is close to the observer, the wavefront of the light that enters the eye of the observer has a small radius of curvature, while if the light source is remote, the wavefront of the light that enters the eye of the observer has a relatively large radius of curvature. The observer recognizes the difference of the radius of curvature and recognizes the perspective.

According to the embodiments, by modifying the curvature of the wavefront forcibly, a natural perspective view (i.e., a perspective view close to an actual view of an object) can be provided.

The laser beam emitted by the wavefront curvature modulating system 100 is incident on the deflection surface 10a of the polygonal mirror 19a. With use of a BD (Beam Detector) sensor (not shown), a rotation speed of the polygonal mirror 19a is detected. Further, the rotation speed and phase are adjusted based on the output of the BD sensor and the horizontal synchronizing signal 5 output by the video signal supplying circuit 3.

The laser beam incident on a deflection surface 19b of the polygonal mirror 19a is scanned in the horizontal direction, and incident on the galvano mirror 21a via the first relaying optical system 20.

The first relaying optical system 20 is arranged such that the deflection surface 19b of the polygonal mirror 19a and the deflection surface 21b of the galvano mirror 21a have a conjugate relationship. Further, a facet error (i.e., tilt of the deflection surfaces 19b) is compensated by the first relaying optical system 20.

The galvano mirror 21a is controlled to swing synchronously with the vertical synchronizing signal so that the laser beam scans in the vertical direction.

Thus, the laser beam is scanned in the horizontal direction by the polygonal mirror 19a, and in the vertical direction by the galvano mirror 21a, thereby the laser beam scans in two-dimensional directions.

The scanning laser beam is incident on the second relaying optical system 22, and then projected on the retina of the observer via the pupil 24 of the observer. With this configuration, the observer can view the image which is directly formed on the retina with the scanning laser beam.

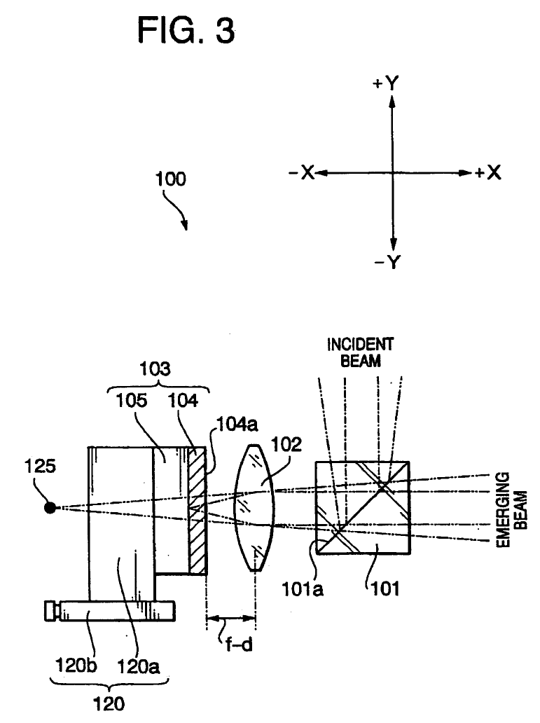

Next, with reference to FIGS. 2 and 3, a method of modifying the wavefront curvature will be described.

FIGS. 2 and 3 show how the laser beam is modulated by the wavefront curvature modulation system 100.

As shown in FIG. 2, the laser beam collimated by the second collimating optical system 18 is incident on the beam splitter 101. In the example shown in FIG. 2, the incident beam proceeds in the −Y direction. As described above, approximately 50% of the incident beam is reflected by the oblique surface 101a, and approximately 50% of the incident beam is transmitted through the oblique surface 101b.

The reflected beam (i.e., the beam reflected by the oblique surface 101a) is incident on the positive lens 102.

It should be noted that, when the driving voltage applied by the driving circuit 23 to the piezoelectric actuator 105 is zero or the predetermined reference voltage, a mirror surface 104a of the movable mirror 104 of the movable mirror 103 is located at a position spaced from the principal point of the positive lens 102 by a distance f, which is a focal length of the positive lens 102. The location of the mirror surface 104a has been adjusted by the observer using the screw-fed fine movement table 120b of the position adjustment mechanism 120.

Since the distance between the mirror surface 104a and the principal point of the positive lens 102 is equal to the focal length f, the laser beam reflected by the oblique surface 101a and incident on the positive lens 102 is converged on the mirror surface 104a. The beam is then reflected by the mirror surface 104a and incident on the positive lens 102 as diverging light.

Since the beam reflected by the mirror surface 104a has a diverging angle which is the same as the converging angle of the beam incident on the mirror surface 104a, and since the reflected beam proceeds along the same optical path as that of the incident beam, the reflected beam is collimated, by the positive lens 102, to have substantially the same diameter of the beam proceeding from the beam splitter 101 to the positive lens 102.

The beam reflected by the mirror surface 104a and collimated by the positive lens 102 is incident on the beam splitter 101. Approximately 50% of the incident beam is transmitted through the oblique surface 101a, and emerges from the beam splitter 101 in a direction perpendicular to the beam incident on the beam splitter from the second collimating optical system 18.

When a certain voltage is applied by the driving circuit 23 to the piezoelectric actuator 105, the movable mirror 104 is displaced in +X direction. In an example shown in FIG. 3, by the movement of the movable mirror 104, a distance between the mirror surface 104a and the principal point of the positive lens 102 is reduced to f−d.

The laser beam emerged from the second collimating optical system 18 is incident on the beam splitter 101, and 50% thereof is reflected by the oblique surface 101a. The beam reflected by the oblique surface 101a is converged by the positive lens 102. As shown in FIG. 3, since the distance between the mirror surface 104a and the principal point of the positive lens 102 is less than the focal length, the laser beam is not converged on the mirror surface 104a. The laser beam is reflected by the mirror surface 104a, and converges after proceeding by a distance d. That is, the laser beam converges at a position whose distance with respect to the principal point of the positive lens 102 is f−2d, and then incident on the positive lens 102 as a divergent beam.

The positive lens 102 refracts the incident beam in a converging direction. However, since the laser beam is converged at a position closer to the positive lens 102 than the focal point thereof, the laser beam is not collimated or converged by the positive lens 102. The beam passed through the positive lens 102 is incident on the beam splitter 101 as the diverging light. Approximately 50% of the light incident on the beam splitter 101 transmits the oblique surface 101a and proceeds as the diverging light, as shown in FIG. 3. Thus, in this case, the wavefront curvature modulating system 100 emits a laser beam having a certain divergence, i.e., a beam having a relatively large wavefront curvature.

The beam emerged from the wavefront modulating system 100 is incident on the polygonal mirror 19a. The curvature of the beam on the deflection surface 19b of the polygonal mirror 19a has the same curvature of a spherical light wave emitted from an apparent light emitting point 125 indicated in FIG. 3. When the distance between the mirror surface 104a and the principal point of the positive lens 102 is f, the wavefront curvature of the light beam on the deflection surface 19b is the same as the light emitted from an apparent light emitting point at the infinity.

As mentioned above, the first relaying optical system 20 is arranged such that the deflection surface 19b of the polygonal mirror 19a and the deflection surface 21b of the galvano mirror 21a have a conjugate relationship. Further, the second relaying optical system 22 is arranged such that the deflection surface 21b of the galvano mirror 21a and the position of the pupil 24 of the observer have the conjugate relationship. Therefore, the deflection surface 19b and the pupil 24 also have the conjugate relationship. Therefore, the wavefront curvature of the laser beam on the deflection surface 19b of the polygonal mirror 19a is the same as the wavefront curvature at the pupil 24 of the observer.

When the observer focuses on the apparent light emitting point 125 of the laser beam incident on the pupil 24, the incident laser beam converges on the retina of the observer.

In the meantime, since the observer can recognize differences of the wavefront curvatures of the laser beam by the focusing (i.e., a so-called ocular accommodation), the observer can recognize the perspective based on the differences of the wavefront curvatures of the laser beam.

That is, when the wavefront curvature is relatively large, the observer feels that the light emitting point is closer, while when the wavefront curvature is relatively small, the observer feels that the light emitting point is farther.

For example, if the focal length of the positive lens 102 is 4 mm, by moving the movable mirror 103 within a range of approximately 30 μm, the wavefront curvature modulating system 100 can express the perspective within a range of approximately 30 cm to the infinity.

If the focal length of the positive lens 102 is 2 mm, by moving the movable mirror 103 within a range of approximately 10 μm, the wavefront curvature modulating system 100 can express the perspective within a range of approximately 30 cm to the infinity.

For example, when the substantially parallel light beam whose wavefront curvature is substantially planar enters the eye of the observer, the observer recognizes that the image is located on a screen at tens of meters away from the observer.

As described above, according to the retinal scanning display device 1, R, G and B laser beams emitted in accordance with the R, G and B video signals supplied by the video signal supplying circuit 3 are combined and incident on the wavefront curvature modulating system 100.

The wavefront curvature modulating system 100 modulates the wavefront curvature of the incident beam and directs the modulated beam to the horizontal scanning system 19. The horizontal scanning system 19 scans the incident beam in the horizontal direction and outputs the same to the vertical scanning system 21. The vertical scanning system 21 scans the incident beam in the vertical direction and directs the scanned beam to the pupil 24 of the observer. The observer recognizes the perspective based on the differences of the wavefront curvatures of the laser beam when projected on the retina.

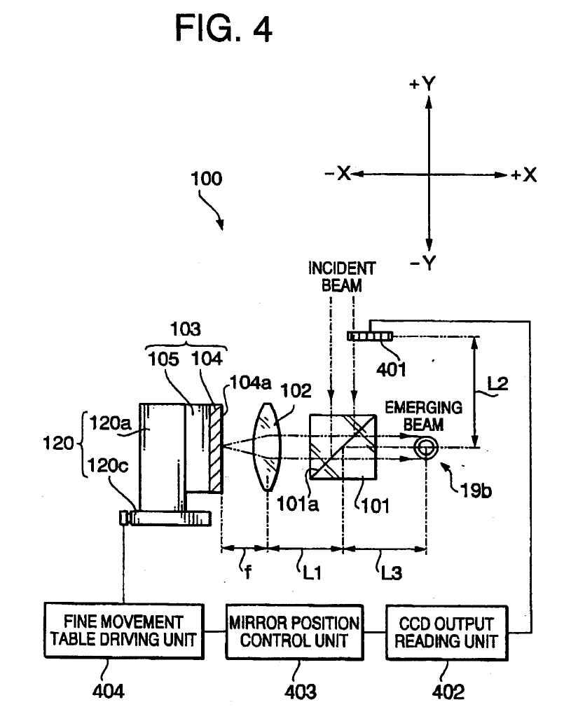

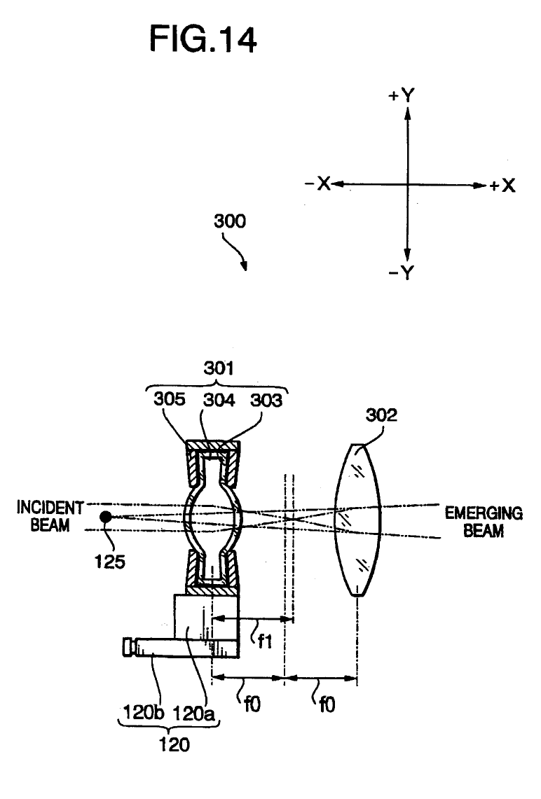

It should be noted that the present invention is not limited to the above-described configuration, and can be modified in various ways. Examples of such modifications will be described with reference to FIGS. 4 through 14.

### FIRST MODIFICATION

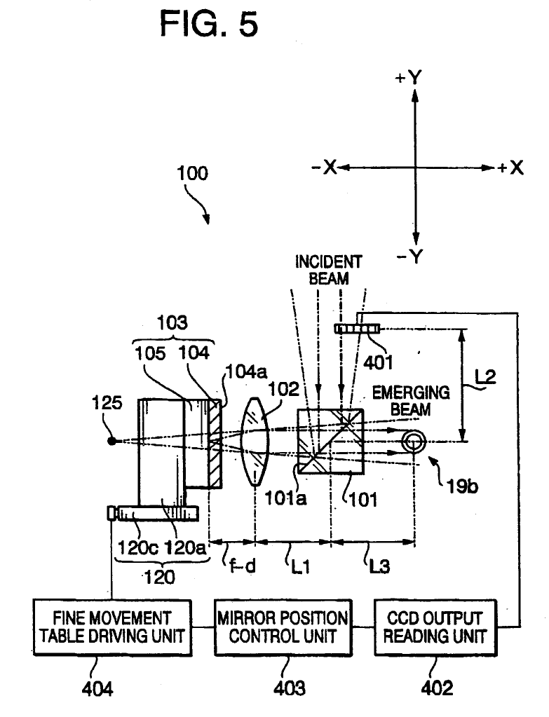

FIGS. 4 and 5 show a configuration of the wavefront curvature modulating system 100A according to a first modification of the above-described embodiment. It should be noted that, in the following description on modifications and another embodiment, the same reference numerals are assigned to the elements similar to those employed in the first embodiment, and description thereof will not be repeated for the sake of brevity.

In the first modification, a CCD (Charge Coupled Device) line sensor 401 is inserted in the optical path on the light incident side, and the reference position of the movable mirror 103 is adjusted by the position adjustment mechanism 120 automatically based on the output of the CCD line sensor 401.

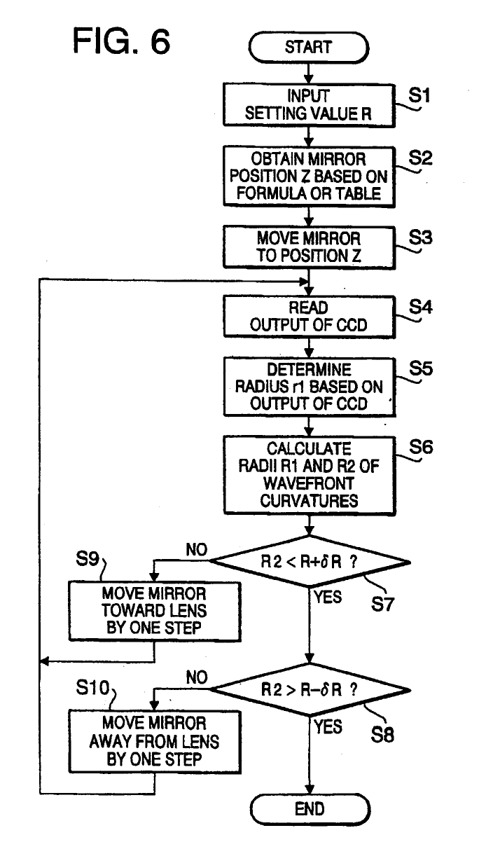

FIG. 6 shows a flowchart illustrating a position adjustment procedure for controlling the position adjustment mechanism 120A based on the output of the CCD line sensor 401.

The position of the movable mirror 103 is adjusted such that when the voltage applied to the piezoelectric actuator 105 by the driving circuit 23 is zero or the predetermined reference voltage, the distance between the mirror surface 104a and the principal point of the positive lens 102 is equal to f (which is the focal length of the positive lens 102). This adjustment is performed by the position adjustment mechanism 120A.

As shown in FIGS. 5 and 6, the position adjustment mechanism 120A is provided with a movable unit 120a and a motor-driven fine movement table 120c. The movable unit 120a is secured on the fine movement table 120c, which is driven by a pulse motor (not shown). Further, the piezoelectric actuator 105 is secured on the movable unit 120a.

On the light incident side of the beam splitter 101, the CCD line sensor 401 is arranged at the position spaced from the central axis of the laser beam by a distance L2 (see FIGS. 4 and 5). The fine movement table 120c is connected with the CCD line sensor 401 via the fine-movement table driving unit 404, a mirror position control unit 403 and a CCD output reading unit 402.

The laser beam incident on the wavefront curvature modulating system 100A (along the −Y direction) is reflected in the −X direction by the oblique surface 101a, and then incident on the positive lens 102 spaced from the oblique surface 101a where the central axis of the beam passes by a distance L1. The laser beam passed through the positive lens 102 is incident on the mirror surface 104a, which is spaced from the principal point of the positive lens 102 by f (in FIG. 4) or by f−d (in FIG. 5), and then reflected to proceed in the +X direction. The reflected beam passes through the positive lens 102, and is incident on the beam splitter 101. Approximately 50% of the incident beam is transmitted through the oblique surface 101a, which approximately 50% of the beam is reflected in the +Y direction. The CCD line sensor 401 is arranged to receive the reflected laser beam.

The laser beam emitted by the wavefront curvature modulating system 100A proceeds in the +X direction in FIGS. 4 and 5, and is converged on the deflection surface 10b of the polygonal mirror 19a (see FIG. 1). A distance between the oblique surface 101a and the deflection surface 19b along the central axis of the laser beam will be referred as a distance L3. Since the first relaying optical system 20 and the second relaying optical system 22 are arranged such that the deflection surface 19b and the pupil 24 have a conjugate relationship, a radius of the wavefront curvature of the laser beam at the pupil 24 is regarded as a radius of the wavefront curvature at the deflection surface 19b.

The CCD line sensor 401 is provided with a plurality of CCD elements, each of which is capable of detecting a laser beam and the intensity thereof. The light amount of the laser beam reflected in the +Y direction by the beam splitter 101 is detected by the CCD line sensor 401, and is transmitted to the CCD output reading unit 402.

In the meantime, the intensity of the laser beam exhibits a Gaussian distribution. That is, on a cross section of the beam, the intensity is smaller at the peripheral portion of the cross section of the beam. The CCD output reading unit 402 detects a position of the cross section of the beam at which the intensity is 1/e² of that on the central axis of the laser beam based on the output of the CCD elements, and outputs the detection signal to the mirror position control unit 403.

The mirror position control unit 403 determines a diameter of the beam by regarding the position detected by the CCD output reading unit 402. Then, the mirror position control unit 403 performs an operation for driving the fine movement table 120c based on the determined beam diameter, and transmits a signal based on the operation results to the fine movement table driving unit 404.

The fine movement table driving unit 404 generates a driving voltage for driving the fine movement table 120c based on the transmitted signal, and applies the voltage to the pulse motor to move the fine movement table 120c in the X-axis direction. With this movement, the movable mirror 103 secured onto the fine movement table 120c moves, and the position of the movable mirror 103 is adjusted. This adjustment procedure will be described further with reference to the flowchart shown in FIG. 6.

In S1, using an inputting system (not shown), a setting value R representative of a position of a virtual image. The setting value R is a predetermined initial value of the wavefront curvature radius. Generally, the initial value is set such that the radius of the wavefront curvature is infinitive. According to the embodiment, a predetermined threshold value (a finite value) which is regarded as the infinity for numerical operation.

Next, the mirror position control unit 403 determines a mirror position Z based on the setting value R and with reference to a predetermined formula or table (S2). Each optical system has an individual difference, and thus includes certain error. However, using a reference optical system, an initial position Z of the movable mirror 104 satisfying the positional relationship between the mirror surface 104a and the principal point of the positive lens 102, and the setting value R corresponding thereto have been determined. Then, an equation expressing a relationship between the values Z and R, or a table indicating the relationship between the values Z and R has been prepared.

The mirror position control unit 403 obtains the position Z of the movable mirror 104 at the initial condition (S2) in order to reduce a loop of operations to compensate for errors in steps after S4.

Further, the mirror position control unit 403 transmits a control signal to the fine movement table driving unit 404 based on the results of the procedure in S2.

The fine movement table driving unit 404 generates a driving voltage for driving the fine movement table 120c based on the Control signal, and applies the same to the fine movement table 120c. Then, the fine movement table 120c is driven such that the movable mirror 103 is moved to the position Z using the pulse motor (S3). That is, in S3, the movable mirror 104 is moved to the initial position Z.

Next, the CCD output reading unit 402 reads the output value of each CCD element (S4). The CCD line sensor 401 receives the intensity of the laser beam proceeding in the +Y direction, and outputs of the CCD elements are transmitted to the CCD output reading unit 402. The CCD output reading unit 402 transmits the read values to the mirror position control unit 403. The mirror position control unit 403 determines which one of the CCD elements obtains the edge of the beam based on the output of the CCD output reading unit 402 and determines the radius r1 of the beam (S5).

In S6, the mirror position control unit 403 calculates a radius R1 of a wavefront curvature of the laser beam reflected to proceed in the +Y direction, and a radius R2 of the wavefront curvature of the beam on the deflection surface 19b which is a position conjugate with the pupil 24 of the observer on assumption that the radius of the incident beam, which is the laser beam before modulated, is r0. That is, the following operations (1) and (2) are performed to obtain the radius R1 of the wavefront curvature on the CCD and the radius R2 of the wavefront curvature on the pupil 24 (S6).

R1=r1(L1+L2−f)/(r1−r0) (1)

R2=R1+(L3−L2) (2)

From formula (1), the radius R1 of the wavefront curvature, i.e., a distance between the apparent light emitting source 125 and the CCD line sensor 401 is obtained. Then, by substituting the radius R1 in formula (2), the radium R2 on the pupil 24 of the observer is obtained.

In S7, the mirror position control unit 403 compares the setting value R with a measured value R2. If R2≧R+δR (S7: NO), the pulse motor is driven by one step to move the movable mirror 103 in a direction toward the positive lens 102 (S9), and control returns to S4. In the above condition, δR represents an allowance of a difference of the radius of the wavefront curvature with respect to the setting value R.

Depending on the value of the allowance δR, the degree of accuracy or error of the radius of the wavefront curvature at the position of the pupil 24 is determined. That is, if the measure radius R2 of the wavefront curvature of the laser beam is greater than the setting value R, the divergence of the laser beam is smaller than the initial value. In such a case, the distance between the positive lens 102 and the movable mirror 103 is too large. In such a case, the mirror position control unit 403 transmits a signal to the fine movement table driving unit 404.

Then the fine movement table driving unit 404 applies a certain voltage to the fine movement table 120c so that the movable mirror 103 approaches the positive lens 102 by one step of the pulse motor (S9).

If R2<R+δR (S7: YES), that is, the measured radius R2 of the wavefront curvature of the laser beam is smaller than the upper limit of the allowable range, the mirror position control unit 403 compares the measured value R2 with the lower limit R−δR of the allowable range. If R2≦R−δR (S8: NO), that is, if the measured radius R2 is equal to or smaller than the lower limit, the movable mirror 103 is moved away from the positive lens 102 by one step (S10). That is, if the measured radius R2 of the wavefront curvature is too small, the divergence of the laser beam is greater than the initial value. In this case, the distance between the ones 102 and the movable mirror 103 is too small. In such a case, the mirror position control unit 403 transmits a signal to the fine movement table driving unit 404 to apply a driving voltage to the fine movement table 120c so that the movable mirror 103 is moved away from the positive lens 102 by one step (S10), and control returns to S4.

If the measured radius R2 is greater than R−δR (S9: YES), a condition:

R−δR<R2<R+δR

is satisfied. That is, the radius R2 is within the allowable range. Thus, the radius of the wavefront curvature falls within the allowable range of the initial value. In this case, the mirror position control unit 403 judges that the position Z of the movable mirror 103 is the initial position, and the procedure shown in FIG. 6 is terminated.

When the procedure shown in FIG. 6 is terminated, the position of the movable mirror has been automatically adjusted to the initial position. Thus, according to the first modification, the same effect as the adjustment made by the observer in the first embodiment can be automatically achieved.

### SECOND MODIFICATION

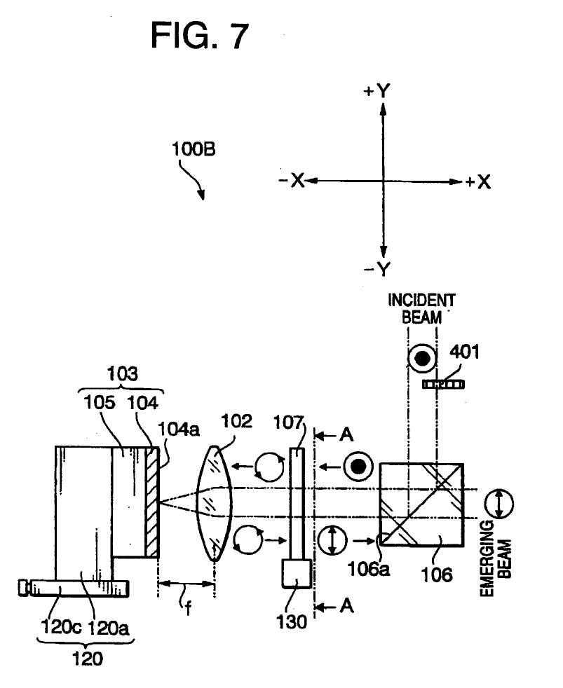

FIG. 7 shows a wavefront curvature modulating system 100B according to a second modification of the embodiment.

In the second modification, instead of the beam splitter 101 shown in FIGS. 1 through 3, a polarizing beam splitter (PBS) 106 is employed. As shown in FIG. 7, the laser beam collimated by the second collimating optical system 108 (see FIG. 1) is incident on the PBS 106.

The light is a kind of an electromagnetic wave, which is a phenomenon where oscillations of an electrical field and a magnetic field propagate. The electromagnetic wave propagates in vacuo at a light speed, and the oscillation directions of the electrical field and the magnetic field are perpendicular to each other and on a plane perpendicular to the propagation direction (i.e., the plane wave). Further, for example, the directions of the oscillation of the light emitted by a filament lamp or the like distribute at various directions, while the electrical field and the magnetic field of the laser beam oscillate in predetermined directions.

The PBS 106 has a beam splitting surface (i.e., an oblique surface) 106a coated with a dielectric multi-layer film, and configured to reflect light having a polarizing direction perpendicular to an X-Y plane, and to transmit light having a polarizing direction parallel with the X-Y plane. If the laser beam having the polarizing direction perpendicular to the X-Y plane is incident on the PBS 106 from the +Y direction, the beam is reflected by the oblique surface 106a to proceed in the −X direction and is incident on a ¼ λ plate 107.

The ¼ λ plate 107 changes the phase difference between the electric field and the magnetic field by ¼λ. When linearly polarized light passes through the ¼ λ plate, it is converted into circularly polarized light, and the circularly polarized light is converted into the linearly polarized light when it passes through the ¼ λ plate.

The laser beam incident on the ¼ λ plate 107 is converted from the linearly polarized beam into the circularly polarized beam which proceeds in the −X direction to enter the positive lens 102. The beam is converged by the positive lens 102 on the mirror surface 104a which is spaced from the principal point of the positive lens 102 by the focal length f. The beam is reflected by the mirror surface 104a to proceed in the +X direction, collimated by the positive lens 102 and is incident on the ¼ λ plate 107. Then, the circularly polarized beam is converted by the ¼ λ plate 107 into the linearly polarized beam, polarizing direction of which is parallel with the X-Y plane, and the beam proceeds to the PBS 106. Since the polarizing direction is parallel with the X-Y plane, the beam incident on the PBS 106 passes through the oblique surface 106a, and is emitted in the +X direction from the wavefront curvature modulating system 100B.

Although not shown, when the movable mirror 103 is moved in the +X direction by an amount d, the wavefront curvature is modulated as described in the embodiment with reference to FIG. 3.

According to the second modification, loss of the light amount when the beam is reflected/transmitted by the oblique surface 106a is less than 10% at each reflection/transmission. Thus, in comparison with the loss of 50% when the beam splitter 101 is used, the loss of the light amount is significantly reduced when the PBS 106 is employed.

According to the second modification, the ¼λ plate 107 is configured to be rotatable, which will be described with reference to FIGS. 7 through 9.

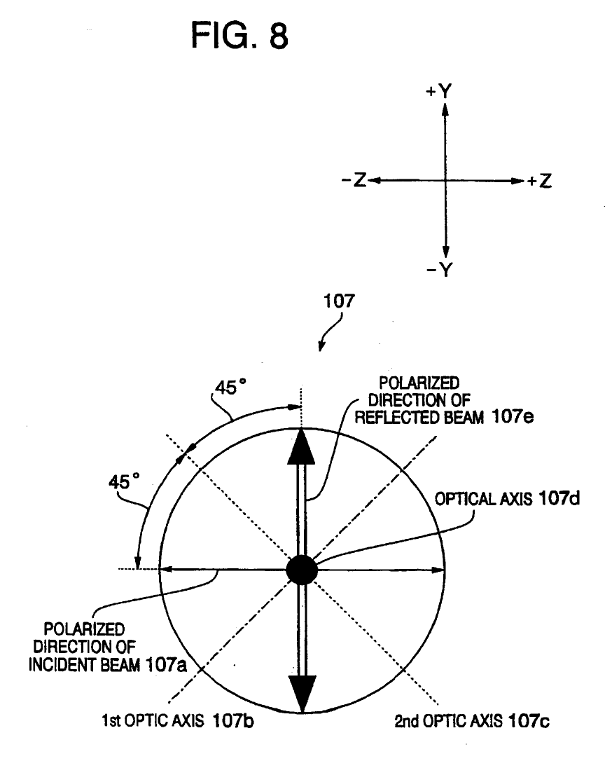

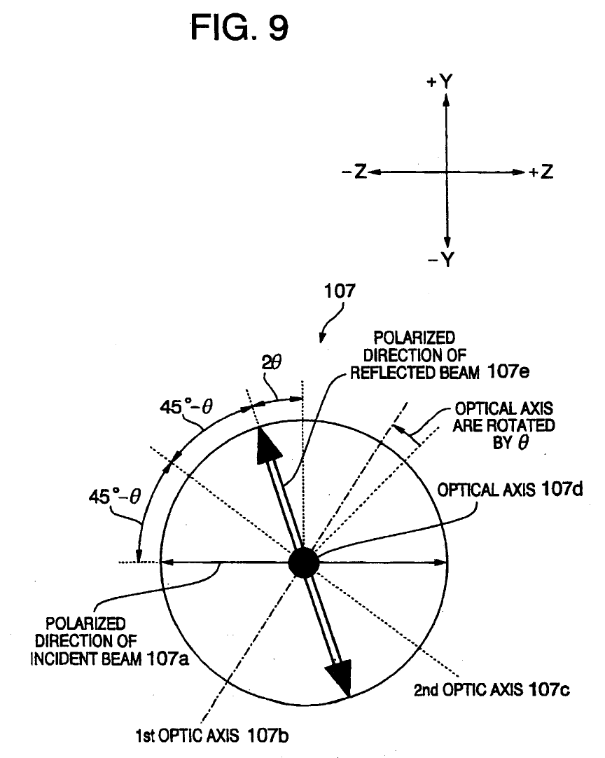

FIGS. 8 and 9 show the ¼ λ plate 107 viewed along arrows A and A′ in FIG. 7. A Z-axis is defined as an axis perpendicular to the X-Y plane. The laser beam enters the ¼λ plate from the +X direction to the −X direction. Before the laser beam enters the ¼ λ plate 107, the polarizing direction 107a thereof is perpendicular to the X-Y plane. In FIGS. 8 and 9, the polarizing direction is defined as the Z-axis direction. The laser beam incident on the ¼ λ plate 107 from the near side of the plane of FIG. 8 or 9 is converted into the circular polarizing beam and reflected by the mirror surface 104a. The reflected beam is then passes through the ¼ λ plate 107 again from the far side of the plane of FIG. 8 or 9, and emerged from the ¼ λ plate 107.

When the ¼ λ plate 107 is not rotated, a first optic axis 107b and a second optic axis 107c extend in directions inclined with respect to Y and Z axes by 45 degrees, respectively. In this case, when the laser beam reflected by the mirror surface 104a and passes through the ¼ λ plate from the rear side of the plane of FIG. 8 to the near side thereof, the polarizing direction 107e coincides with the Y-axis, as indicated in FIG. 8.

FIG. 9 shows a status where the ¼ λ plate 107 is rotated using a rotating mechanism 130 (see FIG. 7) counterclockwise by an angle θ about the optical axis 107d. In this case, the first and second optic axes 107b and 107c extend in directions at 45°−θ with respect to the Y and Z axes, respectively. In this case, when the laser beam is reflected by the mirror surface 104a and passes through the ¼ λ plate from the rear side of the plane of FIG. 9 to the near side thereof, the polarizing direction 107e inclines counterclockwise, with respect to the Y-axis, by 29 as indicated in FIG. 9.

The laser beam reflected by the mirror surface 104a and passed through the ¼ λ plate 107 passes through the PBS 106. By adjusting the rotation angle θ of the ¼ λ plate 107, the amount of light of the beam passing through the oblique surface 106a can be varied. Further, since a part of laser beam reflected by the oblique surface 106a proceeds in the +Y direction, the reflected light can be detected by the CCD line sensor 401 to detect the light amount. Therefore, the radius of the wavefront curvature can be detected using the CCD line sensor 401. Accordingly, it is possible to control the position adjustment mechanism 120 to adjust the position of the movable mirror 103.

### THIRD MODIFICATION

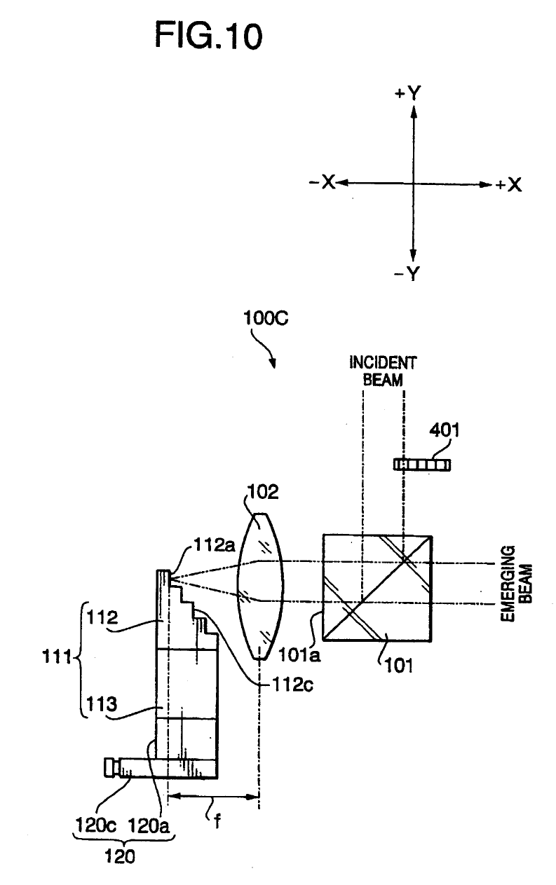

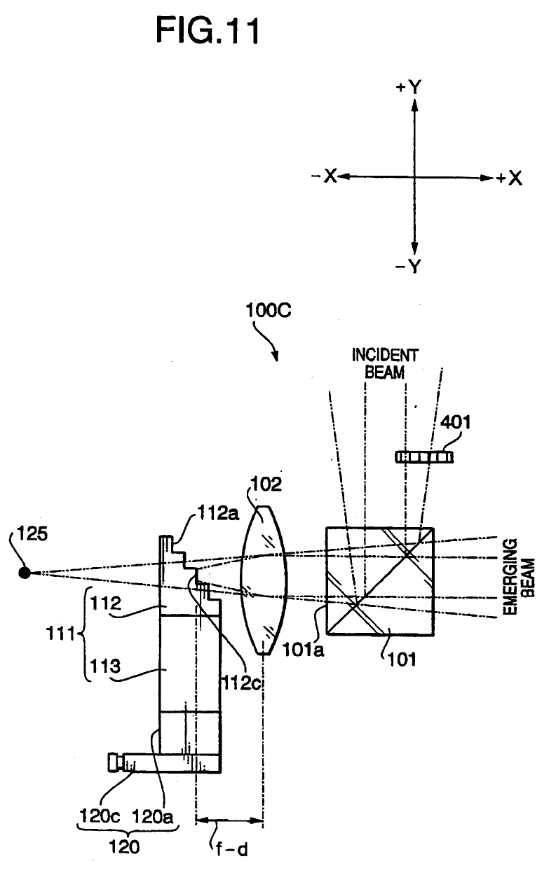

FIGS. 10 and 11 show a wavefront curvature modulating system 100C according to a third modification. In this modification, instead of the movable mirror 103, a movable stepped mirror Ill is employed.

As shown in FIG. 10, the laser beam collimated by the second collimating optical system 18 (see FIG. 1) is incident on the beam splitter 101. Approximately 50% of the incident beam is reflected by the oblique surface 101a of the beam splitter 101 toward the positive lens 102. The laser beam passed through the positive lens 102 is converged at a point which is spaced from the principal point of the positive lens 102 by a distance f, i.e., at the focal point of the positive lens 102.

The movable stepped mirror 111 includes an actuator which moves a mirror unit 112 in the Y-axis direction. The mirror unit 112 has mirror surfaces 112a, 112b, 112c, . . . which are configured such that each surface is perpendicular to the central axis of the laser beam, and the lower surface is closer to the positive lens 102. In the example shown in FIG. 11, the distance between the mirror surface 112a and the principal point of the positive lens 102 is f, and the distance between the mirror surface 112c and the principal point of the positive lens 102 is f−d.

The laser beam passed through the positive lens 102 and proceeds in the −X direction is converged on the mirror surface 112a spaced from the principal point of the positive lens 102 by the distance f, and reflected by the reflection surface 102a to proceed in the +X direction. The reflected laser beam proceeds along the same optical path as that of the incident beam and passes through the positive lens 102. The laser beam is then collimated by the positive lens 102 and incident on the beam splitter 101. Approximately 50% of the beam passes through the oblique surface 101a and emitted from the wavefront curvature modulating system 100C in the +X direction.

When the actuator 113 is actuated to move the mirror unit 112 such that the mirror surface 112c intersects the central axis of the laser beam passed through the positive lens 102 as shown in FIG. 11, the beam passed through the positive lens 102 does not converged on the mirror surface 112c, but converged on a point spaced from the mirror surface 112c by a distance d (i.e., spaced from the principal point of the positive lens 102 by f−2d). The laser beam is then incident on the positive lens 102 as a diverging beam. Since the focal length of the positive lens 102 is f, the laser beam is not collimated by the positive lens 102, and emerged from the positive lens 102 as a diverging beam as if the beam is emitted from the apparent light emitting point 125. The diverging beam is incident on the beam splitter 101, and approximately 50% of the light passes through the oblique surface 101a. Thus, the diverging beam is emitted by the wavefront curvature modulating system 100C.

The eye is capable of recognize differences of the wavefront curvatures. However, it is not so sensitive and the modulation of the wavefront curvature need not be performed continuously from the infinity to the closest distance. For example, by switching the radius of wavefront curvature between 50 cm, 1 m, 3 m, 5 m and the infinity maybe practically effective. In such a case, i.e., the radius is switched among the five steps of distances, only four steps of control voltages are required for actuating the driving circuit 23 to drive the actuator 113. Thus, the circuitry can be simplified.

### Second Embodiment

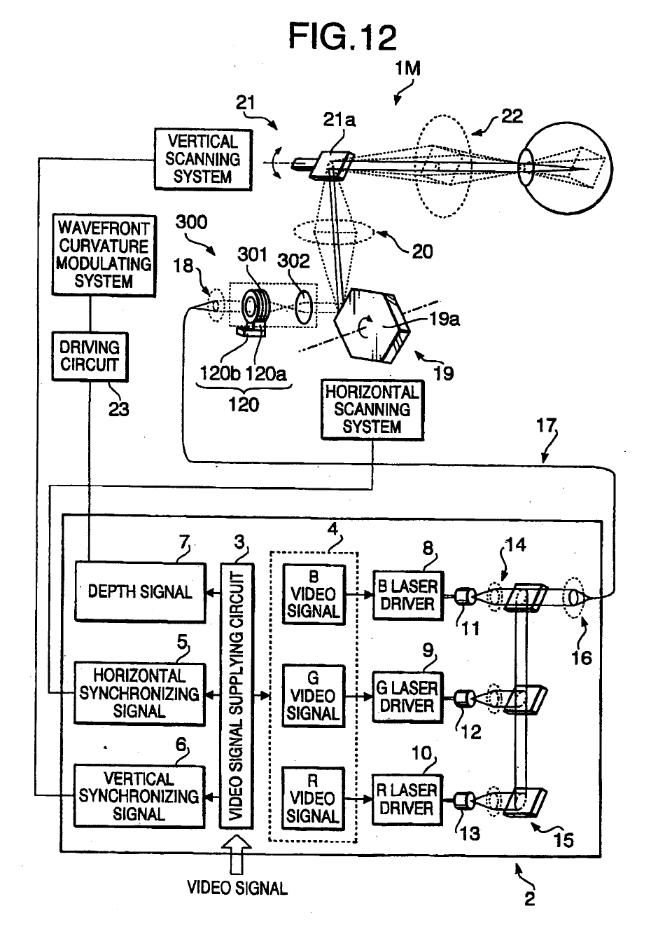

FIGS. 12 through 14 show a wavefront curvature modulating system 300 according to a second embodiment.

In the fourth modification, instead of the movable mirror 103 employed in the wavefront curvature modulating system 100, a variable focal length lens 301 is employed. The substantial structure of a retinal scanning displaying device 1M according to the second embodiment, except for the wavefront curvature modulating system 300, is similar to that of the first embodiment.

Specifically, as shown in FIG. 12, the wavefront curvature modulating system 300 includes a variable focal length lens 301 and a positive lens 302. The variable focal length lens 301 is provided with the position adjustment mechanism 120 including the movable unit 120a and the screw-feeding fine movement table 102b is provided as in the first embodiment.

Individual differences of the variable focal length lens 301 and the positive lens 302 can be cancelled by operating the screw-fed fine movement table 120b to vary the position of the variable focal length lens 301. The entire structure of the retinal scanning display device 1M according to the second embodiment, except for the wavefront curvature modulating system 300, is substantially similar to that of the first embodiment.

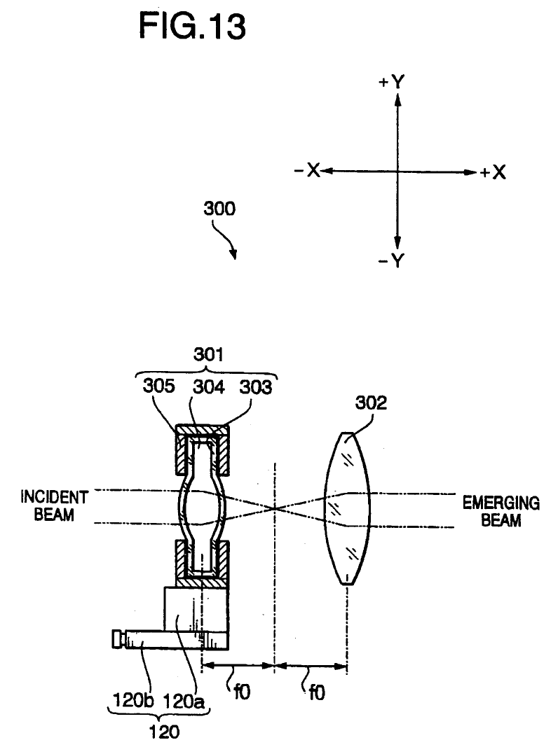

As shown in FIG. 13, the wavefront curvature modulating system includes the variable focal length lens 301, which is configured to have two transparent diaphragms 303 enclosing transparent fluid 304. When a driving voltage is applied to a piezoelectric bimorph 305, it is actuated to deform the diaphragms 303, thereby the focal length of the variable focal length lens 301 is varied.

The laser beam collimated by the second collimating optical system 18 is incident on the variable focal length lens 301 from the −X direction. It should be noted that a distance between the principal point of the variable focal length lens 301 and the positive lens 302 is fixed to 2f0.

With this structure, when the focal length of the variable focal length lens 301 is adjusted to be f0 which is the focal length of the positive lens 302, the laser beam passed through the variable focal length lens 301 converged on a point at the center between the variable focal length lens 301 and the positive lens 302, i.e., at the focal point of the positive lens 302. The beam is then incident on the positive lens 302, which collimates the beam. Thus, in this case, the collimated beam is emitted from the wavefront curvature modulating system 300 in the +X direction.

If the piezoelectric bimorph 305 is driven to deform the diaphragms 303 so that the focal length of the variable focal length lens 301 becomes f1 (f1>f0), the beam incident on the variable focal length lens 301 from the −X direction converges on a point which is closer to the positive lens 302 than the focal point of the positive lens 302. It should be noted that the converging point is spaced from the principal point of the positive lens 302 by 2f0−f1. Then, the beam is incident on the positive lens 302 as a diverging beam. The beam is not collimated by the positive lens 302, and emerges from the positive lens 302 as a diverging beam in the +X direction. The beam emerged from the positive lens 302 has the wavefront curvature which is similar to a beam emitted from an apparent light emitting point 125.

According to the second embodiment, the variable focal length lens 301 is employed. It should be noted that any other optical element whose focal length changes in accordance with variation of its shape and/or physical properties can be employed in place of the variable focal length lens 301.

According to the second embodiment, no beam splitters are employed, and therefore, the loss of light amount is well suppressed. Further, the lens or mirror which may be relatively heavy need not be moved. Accordingly, a delay of modulating timing can be suppressed, and modulation can be performed at an order of tens of Kilohertz.

In the above-described embodiments and modifications, the piezoelectric actuators 105, 110, 113 and the piezoelectric bimorph 305 are employed. However, the invention is not limited to such configurations, and non-piezoelectric actuators such as an electrostatic and/or magnetic actuator can be employed.

It should be noted that the polarizing beam splitter and the ¼ λ plate may be used in association with the movable stepped mirror 111 employed in the third modification.

Further, while the embodiments are described such that the retinal scanning display 1 projects images onto a retina of an eye of the observer, it is also possible to configure the retinal scanning display such that the images are projected into two eyes of the observer. In this case, the feeling of perspective can be enhanced by use of the conventionally known “stereoscopic vision” method employing the binocular parallax, that is, by presenting two images seen from the positions of the right eye and left eye to the right eye and left eye, respectively. In particular, if the feeling of perspective caused by the stereoscopic vision and the feeling of perspective realized by the modulation of the wavefront curvature do not have inconsistency, even though the observer observes the images for a relatively long period, the observer may feel little eyestrain.

The present disclosure relates to the subject matter contained in Japanese Patent Application No. 2002-02176, filed on Jan. 30, 2002, which is expressly incorporated herein by reference in its entirety.

What is claimed is:

1. An image displaying device, comprising:
at least one light source that emits a light beam;
a modulating system that modulates the light beam emitted by said at least one light source in accordance with a video signal;
a wavefront curvature modulating system that modulates a wavefront curvature of the light beam modulated by said modulating system;
a scanning system that scans the light beam modulated by the wavefront curvature modulating system; and
an optical system that directs the light beam scanned by said scanning system to a pupil of an observer thereby forming an image corresponding to he video signal on a retina of an observer,
wherein said wavefront curvature modulating system includes:
an optical element; and
a moving mechanism that moves said optical element in a direction of an axis of the laser beam.

2. The image displaying device according to claim 1,
wherein said optical element includes a reflector that reflect the beam, and
wherein said wavefront curvature modulating system includes:
a polarizing beam splitter that allows a linearly polarized component, which is polarized in a predetermined direction, of the beam modulated by said modulating system to pass through, and reflects another linearly polarized component, which is polarized in a direction perpendicular to the predetermined direction, of the beam modulated by said modulating system;
a light collecting system that collects one of the component passed through the polarizing beam splitter and the reflected component, the collected component being incident on the optical element; and
a ¼ λ plate arranged between the light collecting system and the polarizing beam splitter, wherein said ¼ λ plate is configured to be rotatable on a plane perpendicular to the axis of the beam.

3. The image displaying device according to claim 2, wherein said wavefront curvature modulating system includes a position adjustment mechanism independent of said moving mechanism, a position of said optical element being adjusted with said position adjustment mechanism.

4. The image displaying device according to claim 3,
wherein said wavefront curvature modulating system further includes a light detecting system that detects the beam reflected by said optical system, and
wherein said position adjusting mechanism adjusts a position of said optical element in accordance with a position of the beam detected by said light detecting system.

5. The image displaying device according to claim 1, wherein said wavefront curvature modulating system includes a position adjustment mechanism independent of said moving mechanism, a position of said optical element being adjusted with said position adjustment mechanism.

6. The image displaying device according to claim 5,
wherein said wavefront curvature modulating system further includes a light detecting system that detects the beam reflected by said optical system, and
wherein said position adjusting mechanism adjusts a position of said optical element in accordance with a position of the beam detected by said light detecting system.

7. The image displaying device according to claim 1,
wherein said wavefront curvature modulating system is arranged on a light source side with respect to said scanning system, and
wherein a position at which the beam is incident on said scanning system and a position of the pupil of the observer have a conjugate relationship.

8. An image displaying device, comprising:
at least one light source that emits a light beam;
a modulating system that modulates the light beam emitted by said at least one light source in accordance with a video signal;
a wavefront curvature modulating system that modulates a wavefront curvature of the light beam modulated by said modulating system;
a scanning system that scans the light beam modulated by the wavefront curvature modulating system; and
an optical system that directs the light beam scanned by said scanning system to a pupil of an observer thereby forming an image corresponding to he video signal on a retina of an observer,
wherein said wavefront curvature modulating system includes an optical element provided with a plurality of reflection surfaces which are arranged at different positions along the axis of the beam.

9. The image displaying device according to claim 8, wherein said wavefront curvature modulating system includes a position adjustment mechanism, a position of said optical element being adjusted with said position adjustment mechanism.

10. The image displaying device according to claim 9,
wherein said wavefront curvature modulating system further includes a light detecting system that detects the beam reflected by said optical system, and
wherein said position adjusting mechanism adjusts a position of said optical element in accordance with a position of the beam detected by said light detecting system.

11. The image displaying device according to claim 8,
wherein said wavefront curvature modulating system is arranged on a light source side with respect to said scanning system, and
wherein a position at which the beam is incident on said scanning system and a position of the pupil of the observer have a conjugate relationship.

12. An image displaying device, comprising:
at least one light source that emits a light beam;
a modulating system that modulates the light beam emitted by said at least one light source in accordance with a video signal;
a wavefront curvature modulating system that modulates a wavefront curvature of the light beam modulated by said modulating system;
a scanning system that scans the light beam modulated by the wavefront curvature modulating system; and
an optical system that directs the light beam scanned by said scanning system to a pupil of an observer thereby forming an image corresponding to he video signal on a retina of an observer,
wherein said wavefront curvature modulating system includes a variable focal length optical element whose focal length changes in accordance with variation of at least one of its shape and physical properties.

13. The image displaying device according to claim 12, wherein said wavefront curvature modulating system includes a position adjustment mechanism, a position of said optical element being adjusted with said position adjustment mechanism.

14. The image displaying device according to claim 13,
wherein said wavefront curvature modulating system further includes a light detecting system that detects the beam passed through said variable focal length optical system, and
wherein said position adjusting mechanism adjusts a position of said variable focal length optical element in accordance with a position of the beam detected by said light detecting system.

15. The image displaying device according to claim 12,
wherein said wavefront curvature modulating system is arranged on a light source side with respect to said scanning system, and
wherein a position at which the beam is incident on said scanning system and a position of the pupil of the observer have a conjugate relationship.

16. An image displaying device, comprising:
at least one light source that emits a light beam;
a modulating system that modulates the light beam emitted by said at least one light source in accordance with a video signal;
a scanning system that scans the light beam modulated by the modulating system;
an optical system that directs the light beam scanned by said scanning system to a pupil of an observer thereby forming
an image corresponding to he video signal on a retina of an observer; and
a wavefront curvature modulating system that modulates a wavefront curvature of the light beam.

17. The image displaying device according to claim 16, wherein said wavefront curvature modulating system is arranged on an light source side with respect to said scanning system.

18. The image displaying device according to claim 16, wherein said wavefront curvature modulating system changes a divergence of the beam incident on said scanning system.

19. The image displaying device according to claim 18,
wherein said wavefront curvature modulating system includes:
a first optical system; and
a second optical system that is closer to said scanning system than said first optical system,
the light beam being converged by said first optical system, the light beam converged by said first optical system diverging and entering said second optical system, a point at which the light beam is converged by said first optical system being changeable on a second optical system side with respect to a focal point of said second optical system.
